(19) United States
(12) Patent Application Publication
(10) Pub. No.: US 2015/0379934 A1
(43) Pub. Date: Dec. 31, 2015

(54) Driving Circuit for Organic Light Emitting Diode

(71) Applicant: Shenzhen China Star Optoelectronics Technology Co. Ltd., Shenzhen, Guangdong (CN)

(72) Inventor: Wu Xiaoling, Shenzhen (CN)

(21) Appl. No.: 14/348,889

(22) PCT Filed: Jan. 23, 2014
(86) PCT No.: PCT/CN2014/071288

§ 371 Date: Mar. 31, 2014

(30) Foreign Application Priority Data
Jan. 10, 2014 (CN) 2014110013120.5

(51) Int. Cl. G09G 3/32

(52) U.S. Cl. CPC G09G 3/3266; G09G 3/3258; G09G 2320/045; G09G 2320/0233; G09G 2300/0819; G09G 2310/0216

(57) ABSTRACT

A driving circuit for an OLED includes: a first TFT (T1), a second TFT(T2), a third TFT(T3), a fourth TFT(T4), and a first capacitor (C1). The fourth TFT is added to the present driving circuit based on the conventional 3T1C driving circuit. Benefits of the design are no influence of the threshold voltage, improvement of uniformity and stability of the electric current of the OLED, and improvement of display quality of the OLED. Besides, a data signal is only switched between signals with two different electric potentials, which efficiently solves the problem that a data signal of the conventional driving circuit is switched among signals with three different electric potentials in a cycle while it is hard to realize to switch among signals with three different electric potentials in a cycle.

### BACKGROUND OF THE INVENTION

1. Field of the Invention

The present invention relates to a flat display, and more particularly, to a driving circuit for an organic light emitting diode (OLED).

2. Description of the Prior Art

Features of flat displays are a slim body, energy saving, no radiation, and so on. So flat displays are widely used. Currently, a flat display mainly comprises a liquid crystal display (LCD) and an organic electroluminescence device (OELD). A flat display is an organic light emitting diode (OLED).

The OLED has features such as automatic luminescence, high brightness, wide viewing angle, flexibility, and low power consumption. Owing to these features, the OLED becomes more and more important and is used as a display method. The OLED gradually substitutes conventional LCDs and widely used in the screen of cellphones, the display of computers, and color televisions, etc. Different from conventional LCDs, OELDs do not comprise backlight sources. A very thin organic material coating is disposed on a glass substrate of OELDs. When electric current flows, the organic material coating is illuminated.

Please refer to FIG. 1 showing a driving circuit for a conventional OLED 400. The conventional driving circuit comprises a thin-film transistor (TFT) 100, a TFT 200, and a storage capacitor 300 for realization. The storage capacitor 300 is charged and a controlling voltage is applied on a gate of the TFT 200. Then, the TFT 200 is saturated for supplying the OLED 400 an electric current and enabling the OLED 400 to illuminate. The structure of the conventional driving circuit is simple. But a threshold voltage Vₜₕ (as shown in FIG. 2) of the TFT 200 will be affected when the TFT 200 is influenced by electronics for a long period of time. Further, the threshold voltage Vₜₕ of the TFT 200 will shift and the electric current of the OLED 400 will change, which will affect uniformity of the OLED 400, will cause instability of the OLED 400 in operation, and will reduce the display quality of the OLED 400.

To solve the above-mentioned defects, a TFT 500 is added to a driving circuit of another conventional OLED (as shown in FIG. 3) based on the conventional 2T1C electric circuit. An input voltage of the TFT 500 constantly maintains at a low voltage level Vᵢₙᵢ. The TFT 500 is controlled by a second scanning signal; thereby, a gate-source voltage V_{gs} applied on the TFT 200 is controlled, and the threshold voltage Vₜₕ applied on the TFT 200 is compensated. FIG. 4 shows a timing diagram of the driving circuit of the OLED. At the time of t1, the first scanning signal and the second scanning signal are at a high voltage level V_{gh} (from a low voltage level V_{gl}), a data signal is at the low voltage level Vᵢₙᵢ. The TFT 100 and the TFT 500 are switched on. At this time, an equivalent circuit of the driving circuit is shown in FIG. 5A. A voltage V_{g} applied on the gate of the TFT 200 is Vᵢₙᵢ. A voltage V_{S} applied on the source of the TFT 200 is Vᵢₙᵢ as well. That is, the gate-source voltage applied on the TFT 200 is V_{gs}=V_{g}−Vₛ=0, which means that the gate-source voltage V_{gs} applied on the TFT 200 is smaller than the threshold voltage Vₜₕ at this time. At the time of t2, the first scanning signal maintains at the high voltage level V_{gh}, and the second scanning signal is at the low voltage level V_{gl} (from the high voltage level V_{gh}). The TFT 100 is switched on, and the TFT 500 is switched off. The data signal becomes a referred voltage level V_{ref} (from the low voltage level V_{gl}). At this time, the equivalent circuit of the driving circuit is shown in FIG. 5B. The voltage V_{g} applied on the gate of the TFT 200 is V_{ref}. The voltage Vₛ applied on the source of the TFT 200 keeps Vᵢₘᵢ. If Vᵢₙᵢ=V_{ref}−Vₜₕ stands, the gate-source voltage applied on the TFT 200 is V_{gs}=V_{g}−Vₛ=Vₜₕ. Because the voltage level V_{ref} is higher than the voltage level Vᵢₙᵢ, the capacitor 300 starts to be charged after the time of t2. At the time of t3, the first scanning signal maintains at the high voltage level V_{gh}, and the second scanning signal maintains at the low voltage level V_{gl}. The TFT 100 is switched on, and the TFT 500 is switched off. The data signal is at the high voltage level V_{data} (from the referred voltage level V_{ref}). At this time, the equivalent circuit of the driving circuit is shown in FIG. 5C. The voltage V_{g} applied on the gate of the TFT 200 is V_{data}. The voltage Vₛ applied on the source of the TFT 200 is V_{ref}−Vₜₕ+ΔV(t) where ΔV(t) is a voltage applied on the capacitor 300 during the time of t2 and the time of t3. So, the gate-source voltage applied on the TFT 200 is V_{gs}=V_{data}−V_{ref}+Vₜₕ−ΔV(t) at the time of t3. At the time of t4, the first scanning signal is at the low voltage level V_{gl} (from the high voltage level V_{gh}), and the second scanning signal maintains at the low voltage level V_{gl}. The TFT 100 and the TFT 500 are switched off. At this time, the equivalent circuit of the driving circuit is shown in FIG. 5D. One terminal of the capacitor 300 is directly connected to the gate of the TFT 200. The gate of the TFT 200 varies abruptly. The voltage applied on the two terminals of the capacitor 300 is V_{data}−V_{ref}+Vₜₕ—ΔV(t); that is, the gate-source voltage V_{gs} applied on the TFT 200 maintains V_{data}−V_{ref}+Vₜₕ−ΔV(t). At this time, the driving current in the driving circuit is I=(V_{gs}−Vₜₕ)²=(V_{data}−V_{ref}−Δ V(t)². According to the equation of the driving current of the driving circuit, the driving current is irreverent to the threshold voltage Vₜₕ, which implies that the threshold voltage Vₜₕ cannot affect anything. Therefore, the uniformity and stability of the electric current of the OLED and display quality of the OLED are both improved.

However, the data signal of the driving circuit needs to be switched among signals with three different electric potentials in a cycle while the produced circuit of the conventional data signal is hard to be realized among signals with three different electric potentials.

### SUMMARY OF THE INVENTION

The present invention is to provide a driving circuit for an OLED. A fourth TFT is added to the driving circuit for an OLED based on the conventional 3T1C driving circuit. Benefits of the design are no influence of the threshold voltage, improvement of uniformity and stability of the electric current of the OLED, and improvement of display quality of the OLED. Besides, a data signal of the conventional driving circuit can be successfully switched to a signal with three different electric potentials in a cycle while it is hard to realize to switch among signals with three different electric potentials in a cycle.

According to the present invention, a driving circuit for an organic light emitting diode (OLED) comprises: a first thin-film transistor (TFT), a second TFT, a third TFT, a fourth TFT, and a first capacitor. The first TFT comprises a first gate, a first source, and a first drain. The second TFT comprises a second gate, a second source, and a second drain. The third TFT comprises a third gate, a third source, and a third drain. The fourth TFT comprises a fourth gate, a fourth source, and a fourth drain. The first drain is electrically connected to the second gate, the third drain, and one terminal of the first capacitor, respectively. The second source is electrically connected to the other terminal of the first capacitor and the fourth drain, respectively. The third source is electrically connected to the fourth source.

Furthermore, the driving circuit further comprises a data signal input, a first scanning signal input, a second scanning signal input, and a low voltage level signal input, the data signal input used for inputting a data signal, the first scanning signal input used for inputting a first scanning signal, the second scanning signal input used for inputting a second scanning signal, and the low voltage level signal input used for inputting a first low voltage level signal.

Furthermore, the data signal comprises signals with two different electric potentials, the signals with two different electric potentials are a first high voltage level signal and a second low voltage level signal, and the first low voltage level signal is lower than the second low voltage level signal.

Furthermore, the first gate is electrically connected to the first scanning signal input, and the first source is electrically connected to the data signal input.

Furthermore, the driving circuit further comprises a driving power supply and an OLED, the OLED comprises an anode, an organic material layer formed on the anode, and a cathode formed on the organic material layer.

Furthermore, the second drain is electrically connected to the driving power supply, and the second source, the fourth drain, and the other terminal of the first capacitor are also electrically connected to the anode of the OLED.

Furthermore, the third gate is electrically connected to the second scanning signal input, and the third source and the fourth source are also electrically connected to the low voltage level signal input.

Furthermore, the fourth source is electrically connected to the second scanning signal input.

Furthermore, the cathode of the OLED is grounded.

Furthermore, the driving circuit further comprises a second capacitor, one terminal of the second capacitor is electrically connected to the anode of the OLED, the fourth drain, the second source, and the other terminal of the first capacitor, respectively, and the other terminal of the second capacitor is electrically connected to the cathode of the OLED.

According to the present invention, a driving circuit for an organic light emitting diode (OLED) comprises: a first thin-film transistor (TFT), a second TFT, a third TFT, a fourth TFT, and a first capacitor. The first TFT comprises a first gate, a first source, and a first drain. The second TFT comprises a second gate, a second source, and a second drain. The third TFT comprises a third gate, a third source, and a third drain. The fourth TFT comprises a fourth gate, a fourth source, and a fourth drain. The first drain is electrically connected to the second gate, the third drain, and one terminal of the first capacitor, respectively. The second source is electrically connected to the other terminal of the first capacitor and the fourth drain, respectively. The third source is electrically connected to the fourth source. The driving circuit further comprises a data signal input, a first scanning signal input, a second scanning signal input, and a low voltage level signal input. The data signal input used for inputting a data signal, the first scanning signal input used for inputting a first scanning signal, the second scanning signal input used for inputting a second scanning signal, and the low voltage level signal input used for inputting a first low voltage level signal. The data signal comprises signals with two different electric potentials. The signals with two different electric potentials are a first high voltage level signal and a second low voltage level signal, and the first low voltage level signal is lower than the second low voltage level signal. The first gate is electrically connected to the first scanning signal input, and the first source is electrically connected to the data signal input. The driving circuit further comprises a driving power supply and an OLED, the OLED comprises an anode. An organic material layer formed on the anode, and a cathode formed on the organic material layer. The second drain is electrically connected to the driving power supply, and the second source, the fourth drain, and the other terminal of the first capacitor are also electrically connected to the anode of the OLED.

Furthermore, the third gate is electrically connected to the second scanning signal input, and the third source and the fourth source are also electrically connected to the low voltage level signal input.

Furthermore, the fourth source is electrically connected to the second scanning signal input.

Furthermore, the cathode of the OLED is grounded.

Furthermore, the driving circuit further comprises a second capacitor, one terminal of the second capacitor is electrically connected to the anode of the OLED, the fourth drain, the second source, and the other terminal of the first capacitor, respectively, and the other terminal of the second capacitor is electrically connected to the cathode of the OLED.

The present invention provides a benefit as follows: A fourth TFT is added to a driving circuit for an OLED based on the conventional 3T1C driving circuit. Benefits of the design are no influence of the threshold voltage, improvement of uniformity and stability of the electric current of the OLED, and improvement of display quality of the OLED. Besides, a data signal is only switched between signals with two different electric potentials, which efficiently solves the problem that a data signal of the conventional driving circuit is switched among signals with three different electric potentials in a cycle while it is hard to realize to switch among signals with three different electric potentials in a cycle.

These and other objectives of the present invention will become apparent to those of ordinary skill in the art after reading the following detailed description of the preferred embodiment that is illustrated in the various figures and drawings.

### BRIEF DESCRIPTION OF THE DRAWINGS

FIG. 1 shows a conventional driving circuit for driving an OLED.

FIG. 2 shows an offset of threshold voltage of the TFT shown in FIG. 1.

FIG. 3 shows another conventional driving circuit for driving an OLED.

FIG. 4 shows a timing diagram of the driving circuit.

FIG. 5A is an equivalent circuit diagram of the driving circuit of FIG. 3 at a moment t1 of FIG. 4.

FIG. 5B is an equivalent circuit diagram of the driving circuit of FIG. 3 at a moment t2 of FIG. 4.

FIG. 5C is an equivalent circuit diagram of the driving circuit of FIG. 3 at a moment t3 of FIG. 4.

FIG. 5D is an equivalent circuit diagram of the driving circuit of FIG. 3 at a moment t4 of FIG. 4.

FIG. 6 illustrates a driving circuit for an OLED according to one embodiment of the present invention.

FIG. 7 shows a timing diagram of the driving circuit in FIG. 6.

FIG. 8 is an equivalent circuit diagram of the driving circuit of FIG. 6 at a moment t1 of FIG. 7.

FIG. 9 is an equivalent circuit diagram of the driving circuit of FIG. 6 at a moment t2 of FIG. 7.

FIG. 10 is an equivalent circuit diagram of the driving circuit of FIG. 6 at a moment t3 of FIG. 7.

FIG. 11 is an equivalent circuit diagram of the driving circuit of FIG. 6 at a moment t4 of FIG. 7.

FIG. 12 illustrates a driving circuit for an OLED according to another embodiment of the present invention.

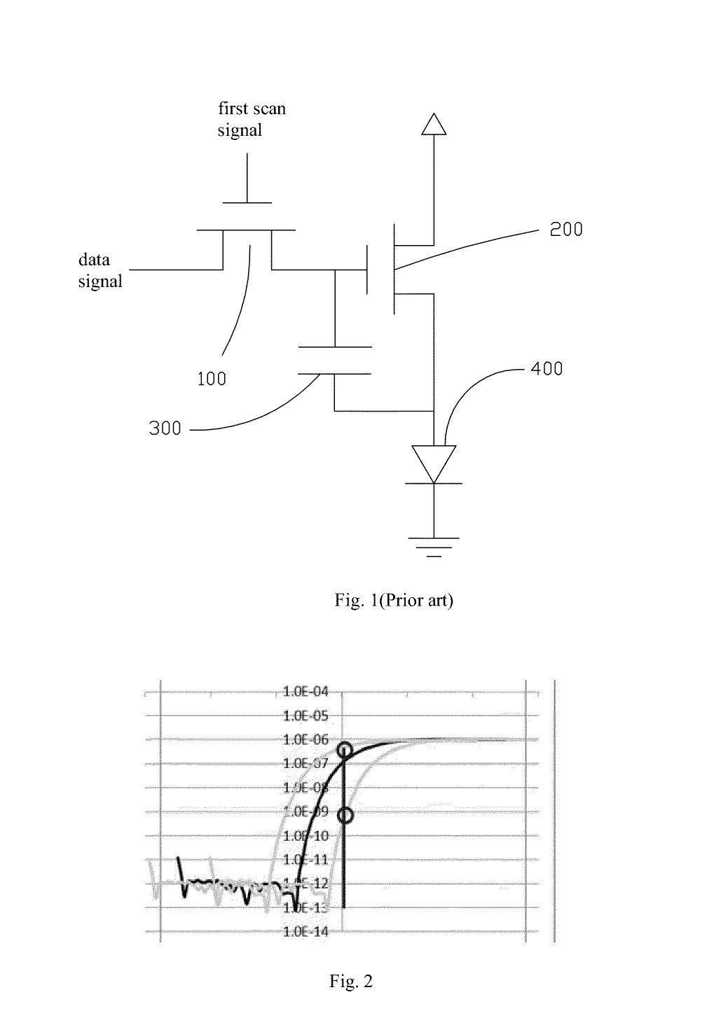

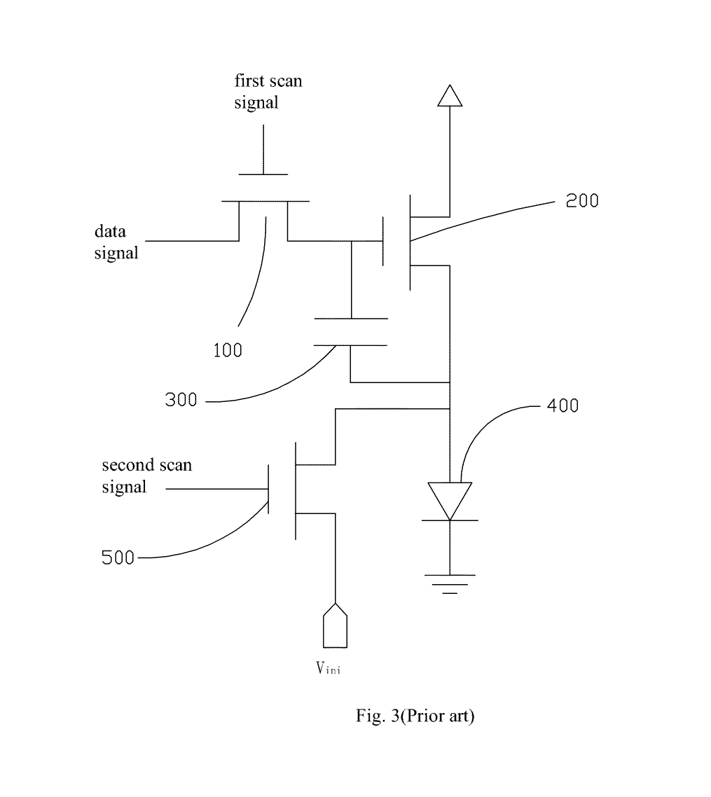

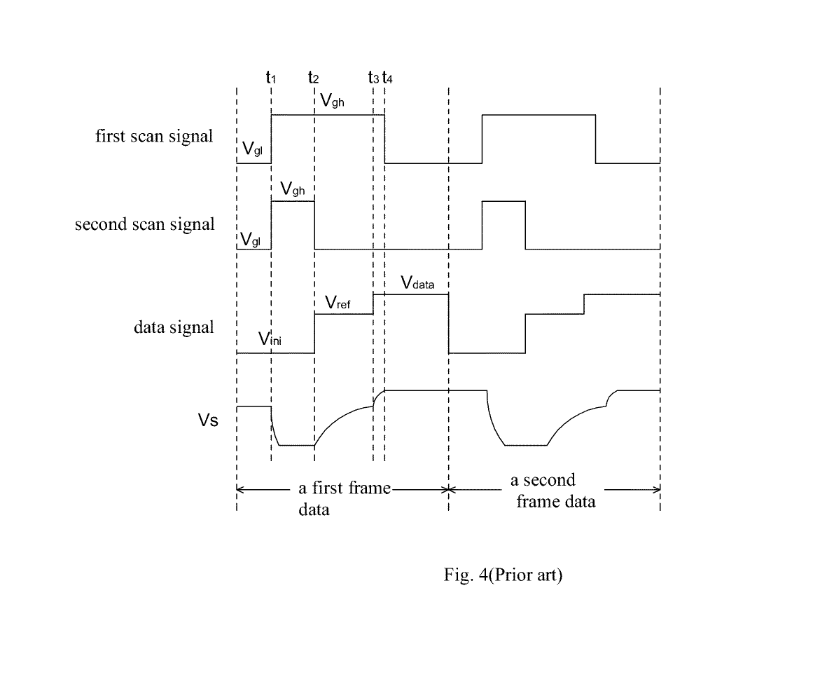

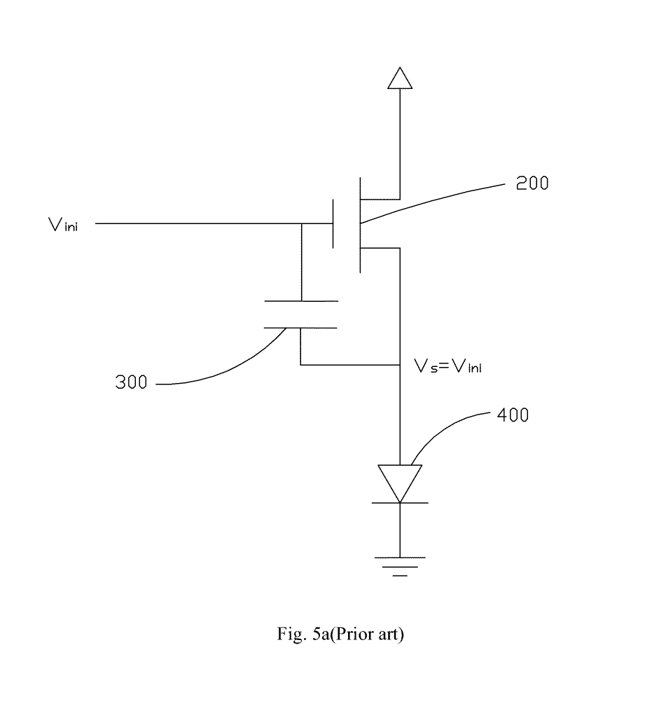

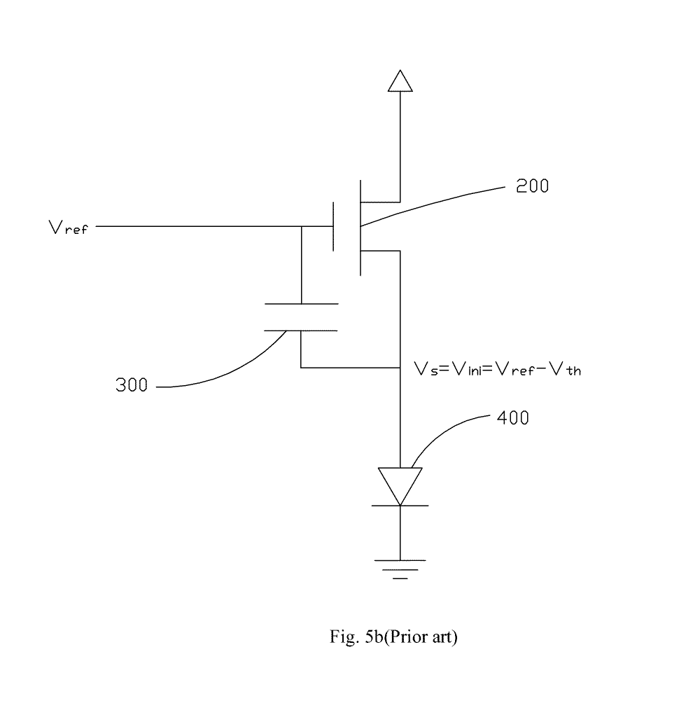

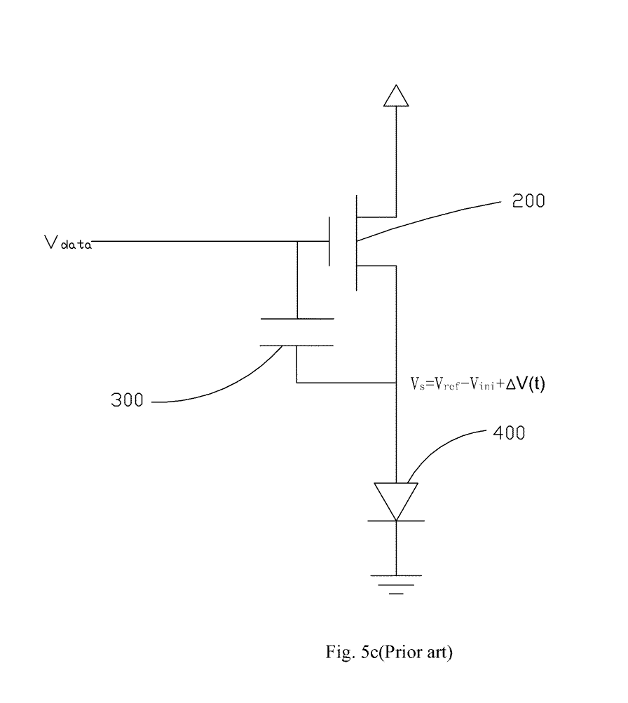

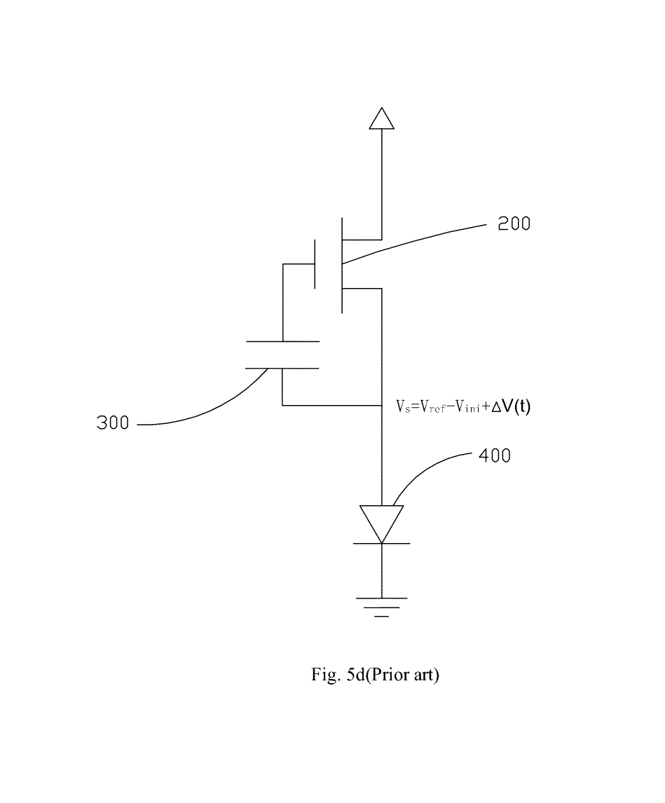

### DETAILED DESCRIPTION OF THE PREFERRED EMBODIMENTS

The present invention is described in detail in conjunction with the accompanying drawings and embodiments.

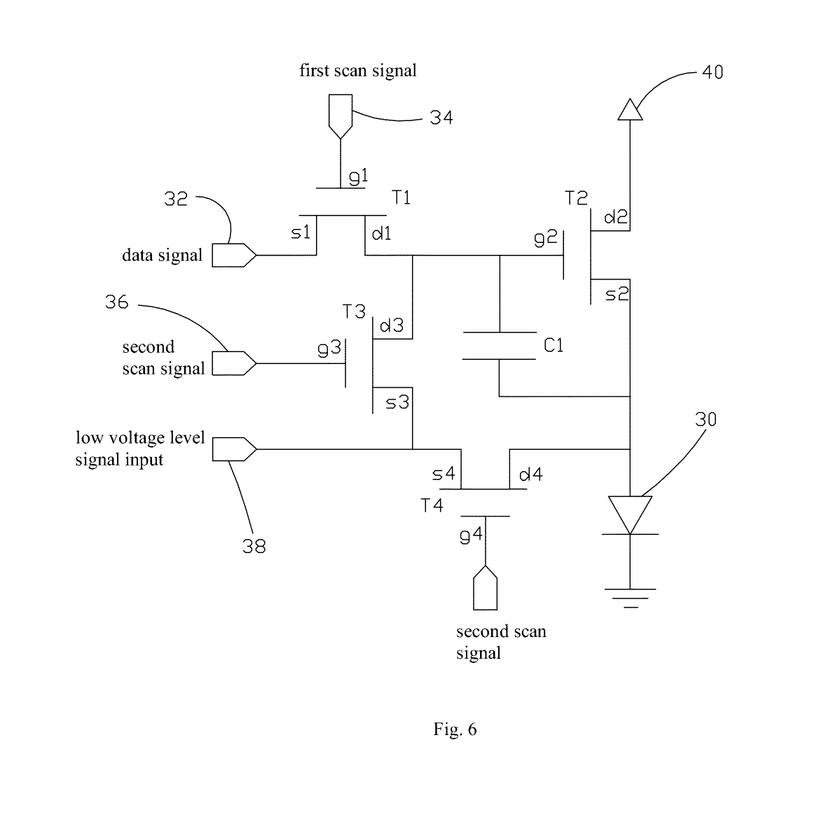

Please refer to FIG. 6 illustrating a driving circuit for an OLED according to one embodiment of the present invention. The driving circuit comprises a first TFT T1, a second TFT T2, a third TFT T3, a fourth TFT T4, and a first capacitor C₁. The first TFT T1 comprises a first gate g1, a first source s1, and a first drain d1. The second TFT T2 comprises a second gate g2, a second source s2, and a second drain d2. The third TFT T3 comprises a third gate g3, a third source s3, and a third drain d3. The fourth TFT T4 comprises a fourth gate g4, a fourth source s4, and a fourth drain d4. The first drain d1 is electrically connected to the second gate g2, the third drain d3, and one terminal of the first capacitor C₁, respectively. The second source s2 is electrically connected to the other terminal of the first capacitor C₁ and the fourth drain d4, respectively. The third source s3 is electrically connected to the fourth source s4.

Further, the driving circuit for the OLED further comprises a data signal input 32, a first scanning signal input 34, a second scanning signal input 36, and a low voltage level signal input 38. The data signal input 32 is used for inputting a data signal. The first scanning signal input 34 is used for inputting a first scanning signal. The second scanning signal input 36 is used for inputting a second scanning signal. The low voltage level signal input 38 is used for inputting a first low voltage level signal.

The driving circuit for the OLED further comprises a driving power supply 40 and an OLED 30. The OLED 30 comprises an anode, an organic material layer formed on the anode, and a cathode formed on the organic material layer. The cathode of the OLED 30 is grounded.

Specifically, the first gate g1 is electrically connected to the first scanning signal input 34. The first source s1 is electrically connected to the data signal input 32. The second drain d2 is electrically connected to the driving power supply 40. The second source s2, the fourth drain d4, and the other terminal of the first capacitor C₁ are also electrically connected to the anode of the OLED 30. The third gate g3 is electrically connected to the second scanning signal input 36. The third source s3 and the fourth source s4 are also electrically connected to the low voltage level signal input 38. The fourth gate g4 is electrically connected to the second scanning signal input 36.

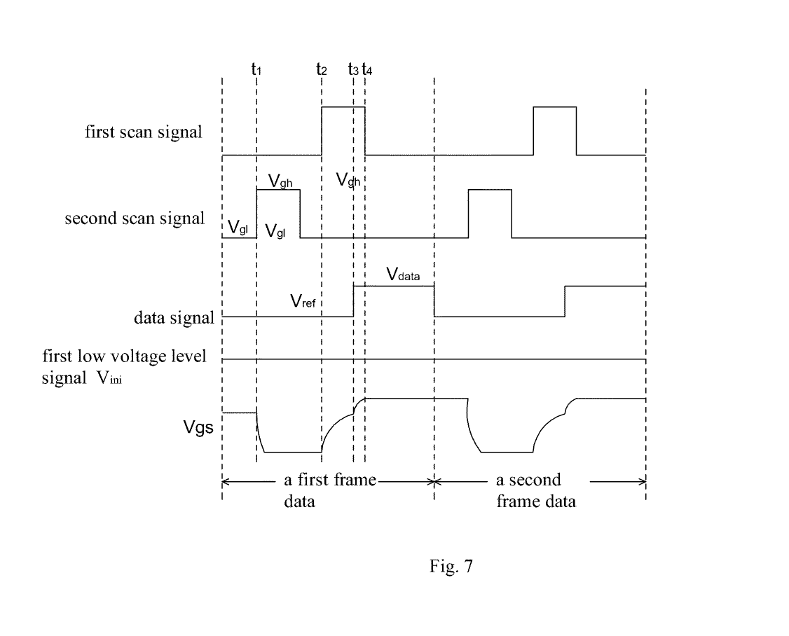

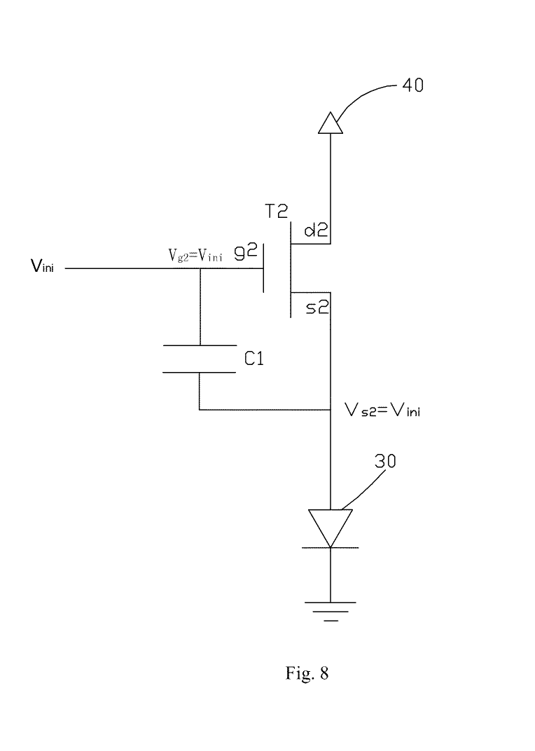

Please refer to FIG. 7 showing a timing diagram of the driving circuit of the OLED in the present invention and FIGS. 8-11. In the present invention, the data signal only comprises signals with two different electric potentials in one cycle, which is good for realization and efficiently solves the problem that a data signal of the conventional driving circuit is switched among signals with three different electric potentials in a cycle while it is hard to realize to switch among signals with three different electric potentials in a cycle. The signals with two different electric potentials that the data signal comprises are a first high voltage level signal and a second low voltage level signal. The first high voltage level signal is lower than the second low voltage level signal.

Specifically, the first scanning signal is a low voltage level scanning signal V_{gl} at the time of t1. The first TFT T1 is switched off. The second scanning signal is switched from the low voltage level scanning signal V_{gl} to the high voltage level scanning signal V_{gh}. A third sample TFT T3 and a fourth sample TFT T4 are conducted. The data signal is the second low voltage level signal V_{ref}. FIG. 8 shows an equivalent circuit of the driving circuit as shown in FIG. 6. A voltage applied on the gate of the second TFT T2 is V_{g2}=Vᵢₙᵢ. A voltage applied on the source of the second TFT T2 is Vₛ₂=Vᵢₙᵢ. That is, a gate-source voltage applied on the second TFT T2 is V_{gs}=V_{g2}−Vₛ₂=0. The gate-source voltage V_{gs} applied on the second TFT T2 is smaller than the threshold voltage Vₜₕ.

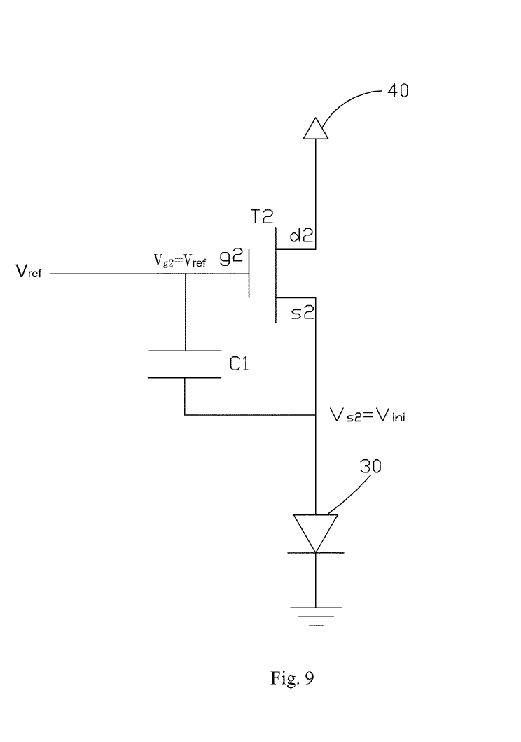

At the time of t2, the first scanning signal is switched from the low voltage level scanning signal V_{gl} to the high voltage level scanning signal V_{gh}. The first TFT T1 is conducted. The second scanning signal is the low voltage level scanning signal V_{gl}. The third sample TFT T3 and the fourth sample TFT T4 are switched off. The data signal remains the second low voltage level signal V_{ref}. FIG. 9 shows an equivalent circuit of the driving circuit as shown in FIG. 6. A voltage applied on the gate of the second TFT T2 is V_{g2}=V_{ref}. A voltage applied on the source of the second TFT T2 is Vₛ₂=Vᵢₙᵢ. That is, the gate-source voltage applied on the second TFT T2 is V_{gs}=V_{g2}−Vₛ₂=V_{ref}−Vᵢₙᵢ. If Vᵢₙᵢ=V_{ref}−Vₜₕ stands, the gate-source voltage applied on the second TFT T2 is V_{gs}=V_{g2}−Vₛ₂=Vₜₕ. The second low voltage level signal V_{ref} is higher than the first low voltage level signal Vᵢₙᵢ. After the time of t2, the first capacitor starts to be charged.

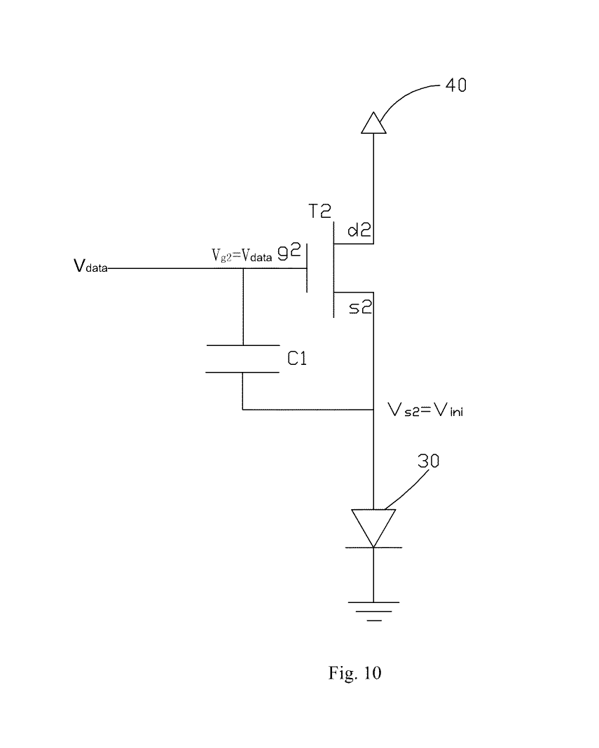

At the time of t3, the first scanning signal is the high voltage level scanning signal V_{gh}. The first TFT T1 is conducted. The second scanning signal is the low voltage level scanning signal V_{gl}. The third sample TFT T3 and the fourth sample TFT T4 are switched off. The data signal is switched from the second low voltage level signal V_{ref} to the high voltage level signal V_{data}. FIG. 10 shows an equivalent circuit of the driving circuit as shown in FIG. 6. A voltage applied on the gate of the second TFT T2 is V_{g2}=V_{data}. The source of the second TFT T2 is charged by the first capacitor C1, and a voltage applied on the source of the second TFT T2 is Vₛ₂=V_{ref}−Vₜₕ+ΔV(t). ΔV(t) refers to the voltage charged by the first capacitor C1 during the time of t2 and the time of t3; that is, the gate-source voltage applied on the second TFT T2 is V_{gs}=V_{g2}−Vₛ₂=V_{data}−V_{ref}+Vₜₕ−ΔV(t).

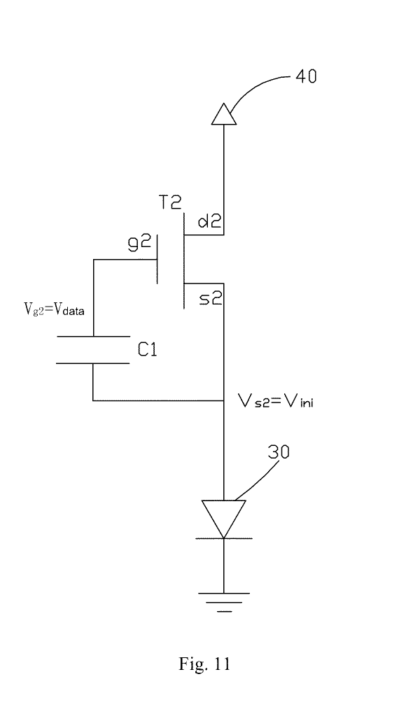

At the time of t4, the first scanning signal is switched to the low voltage level scanning signal V_{gl} from the high voltage level scanning signal V_{gh}. The first TFT T1 is switched off. The second scanning signal remains the low voltage level scanning signal V_{gl}. The third and fourth sample transistors T3 and T4 are switched off. FIG. 11 shows an equivalent circuit of the driving circuit as shown in FIG. 6. Although the voltage applied on the gate of the second TFT T2 varies abruptly, one terminal of the first capacitor C1 is directly connected to the gate of the second TFT T2. The first capacitor C1 is used for storage. When the voltage applied on the gate of the second TFT T2 varies abruptly (at the time of t4), the voltage applied on the terminals of the first capacitor C1 remains V_{data}−V_{ref}+Vₜₕ−ΔV(t). The gate-source voltage applied on the second TFT T2 is V_{gs}=V_{data}−V_{ref}+Vₜₕ−ΔV(t). The driving current of the driving circuit is I=(V_{gs}−Vₜₕ)²=(V_{data}−V_{ref}−ΔV(t)². This equation implies that the driving circuit is irreverent to the threshold voltage Vₜₕ. In other words, the threshold voltage Vₜₕ has no influence on the driving circuit, uniformity and stability of the electric current of the OLED as well as display quality of the OLED are improved.

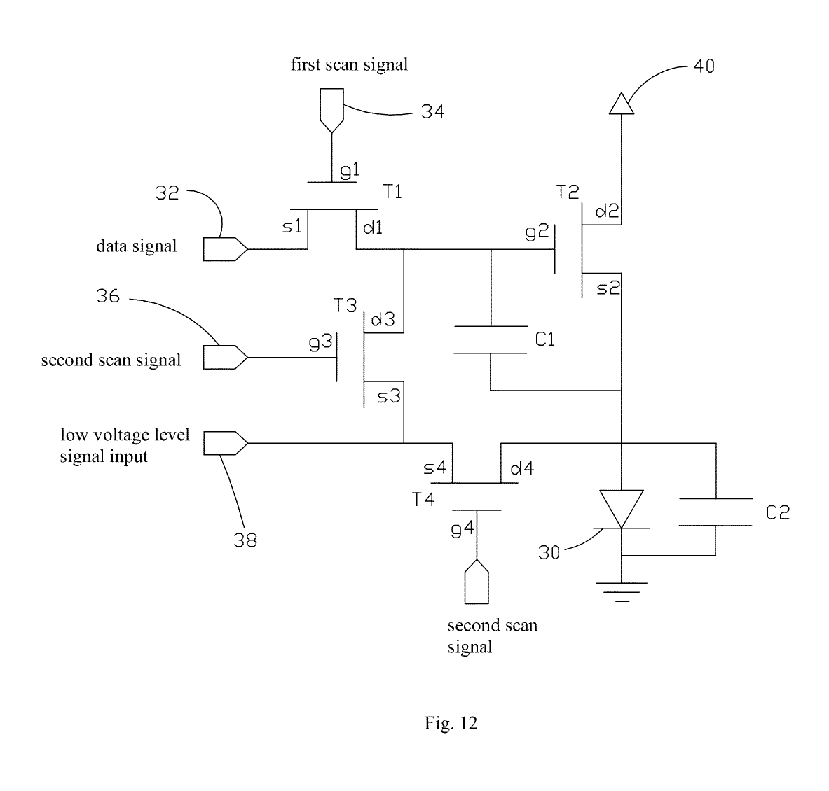

Please refer to FIG. 12 showing a driving circuit for the OLED according to another preferred embodiment of the present invention. The driving circuit of the present embodiment is typically identical to the driving circuit shown in FIG. 6. The difference is that a second capacitor C₂ is newly added to the driving circuit in the present embodiment. One terminal of the second capacitor C₂ is electrically connected to the anode of the OLED 30, the fourth drain d4, the second source s2, and the other terminal of the first capacitor C₁, respectively. The other terminal of the second capacitor C₂ is electrically connected to the cathode of the OLED 30. The second capacitor C₂ further improves uniformity and stability of the electric current of the OLED 30 as well as display quality of the OLED 30.

To conclude, a fourth TFT is added to the present driving circuit for the present OLED based on the conventional 3T1C driving circuit. Benefits of the design are no influence of the threshold voltage, improvement of uniformity and stability of the electric current of the OLED, and improvement of display quality of the OLED. Besides, a data signal is only switched between signals with two different electric potentials, which efficiently solves the problem that a data signal of the conventional driving circuit is switched among signals with three different electric potentials in a cycle while it is hard to realize to switch among signals with three different electric potentials in a cycle.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A driving circuit for an organic light emitting diode (OLED), comprising: a first thin-film transistor (TFT), a second TFT, a third TFT, a fourth TFT, and a first capacitor, the first TFT comprising a first gate, a first source, and a first drain, the second TFT comprising a second gate, a second source, and a second drain, the third TFT comprising a third gate, a third source, and a third drain, the fourth TFT comprising a fourth gate, a fourth source, and a fourth drain, the first drain being electrically connected to the second gate, the third drain, and one terminal of the first capacitor, respectively, the second source being electrically connected to the other terminal of the first capacitor and the fourth drain, respectively, and the third source being electrically connected to the fourth source.

2. The driving circuit as claimed in claim 1, wherein the driving circuit further comprises a data signal input, a first scanning signal input, a second scanning signal input, and a low voltage level signal input, the data signal input used for inputting a data signal, the first scanning signal input used for inputting a first scanning signal, the second scanning signal input used for inputting a second scanning signal, and the low voltage level signal input used for inputting a first low voltage level signal.

3. The driving circuit as claimed in claim 2, wherein the data signal comprises signals with two different electric potentials, the signals with two different electric potentials are a first high voltage level signal and a second low voltage level signal, and the first low voltage level signal is lower than the second low voltage level signal.

4. The driving circuit as claimed in claim 2, wherein the first gate is electrically connected to the first scanning signal input, and the first source is electrically connected to the data signal input.

5. The driving circuit as claimed in claim 1, wherein the driving circuit further comprises a driving power supply and an OLED, the OLED comprises an anode, an organic material layer formed on the anode, and a cathode formed on the organic material layer.

6. The driving circuit as claimed in claim 5, wherein the second drain is electrically connected to the driving power supply, and the second source, the fourth drain, and the other terminal of the first capacitor are also electrically connected to the anode of the OLED.

7. The driving circuit as claimed in claim 2, wherein the third gate is electrically connected to the second scanning signal input, and the third source and the fourth source are also electrically connected to the low voltage level signal input.

8. The driving circuit as claimed in claim 2, wherein the fourth source is electrically connected to the second scanning signal input.

9. The driving circuit as claimed in claim 5, wherein the cathode of the OLED is grounded.

10. The driving circuit as claimed in claim 9, wherein the driving circuit further comprises a second capacitor, one terminal of the second capacitor is electrically connected to the anode of the OLED, the fourth drain, the second source, and the other terminal of the first capacitor, respectively, and the other terminal of the second capacitor is electrically connected to the cathode of the OLED.

11. A driving circuit for an organic light emitting diode (OLED), comprising: a first thin-film transistor (TFT), a second TFT, a third TFT, a fourth TFT, and a first capacitor, the first TFT comprising a first gate, a first source, and a first drain, the second TFT comprising a second gate, a second source, and a second drain, the third TFT comprising a third gate, a third source, and a third drain, the fourth TFT comprising a fourth gate, a fourth source, and a fourth drain, the first drain being electrically connected to the second gate, the third drain, and one terminal of the first capacitor, respectively, the second source being electrically connected to the other terminal of the first capacitor and the fourth drain, respectively, and the third source being electrically connected to the fourth source;
wherein the driving circuit further comprises a data signal input, a first scanning signal input, a second scanning signal input, and a low voltage level signal input, the data signal input used for inputting a data signal, the first scanning signal input used for inputting a first scanning signal, the second scanning signal input used for inputting a second scanning signal, and the low voltage level signal input used for inputting a first low voltage level signal;
wherein the data signal comprises signals with two different electric potentials, the signals with two different electric potentials are a first high voltage level signal and a second low voltage level signal, and the first low voltage level signal is lower than the second low voltage level signal;
wherein the first gate is electrically connected to the first scanning signal input, and the first source is electrically connected to the data signal input;
wherein the driving circuit further comprises a driving power supply and an OLED, the OLED comprises an anode, an organic material layer formed on the anode, and a cathode formed on the organic material layer;
wherein the second drain is electrically connected to the driving power supply, and the second source, the fourth drain, and the other terminal of the first capacitor are also electrically connected to the anode of the OLED.

12. The driving circuit as claimed in claim 11, wherein the third gate is electrically connected to the second scanning signal input, and the third source and the fourth source are also electrically connected to the low voltage level signal input.

13. The driving circuit as claimed in claim 11, wherein the fourth source is electrically connected to the second scanning signal input.

14. The driving circuit as claimed in claim 11, wherein the cathode of the OLED is grounded.

15. The driving circuit as claimed in claim 14, wherein the driving circuit further comprises a second capacitor, one terminal of the second capacitor is electrically connected to the anode of the OLED, the fourth drain, the second source, and the other terminal of the first capacitor, respectively, and the other terminal of the second capacitor is electrically connected to the cathode of the OLED.
